(19) United States
(12) Patent Application Publication
(10) Pub. No.: US 2019/0222109 A1
(43) Pub. Date: Jul. 18, 2019

(54) Multi-Level and Multi-Loop Predictor Based Pulse Skipping Modulation

(71) Applicant: Dialog Semiconductor (UK) Limited, London (GB)

(72) Inventors: Pietro Gambetta, Livorno (IT); Michele Lai, Pisa (IT)

(21) Appl. No.: 16/146,524

(22) Filed: Sep. 28, 2018

(51) Int. Cl. H02M 1/088; H02M 3/158

(52) U.S. Cl. CPC H02M 1/088; H02M 2001/0048; H02M 3/1582

(57) ABSTRACT

A switching power converter circuit and methods are presented. The circuit has a power stage with switching elements, a feedback loop for generating an error voltage, a modulator circuit for controlling switching operation of the power stage based on the error voltage, a prediction circuit, and a comparison circuit for comparing the prediction of the error voltage to an actual value of the error voltage and for instructing the modulator circuit to enter a pulse skipping mode based on a result of the comparison. Also, a switching power converter circuit that has a prediction circuit for generating a prediction of the drive signal for the power stage and a comparison circuit for comparing the prediction of the drive signal to the actual drive signal and for instructing the modulator circuit to enter a pulse skipping mode based on a result of the comparison.

### TECHNICAL FIELD

This disclosure relates to switching power converter circuits (e.g., DC-DC converters) for receiving an input power at an input node and outputting an output power at an output node, and to corresponding methods of power conversion using switching power converter circuits. This disclosure is particularly applicable to multi-level and/or multi-loop switching power converter circuits and to corresponding methods of power conversion using such switching power converter circuits.

### BACKGROUND

DC/DC converters (as examples of switching power converters) are characterized by two main sources of losses, switching losses and ohmic losses. The relative impact of these losses depends on the current load that is applied to the converter (if standard PWM modulation is used).

An example of the efficiency of a DC/DC converter as a function of the current load is schematically illustrated in FIG. 1. As can be seen, lightly-loaded converters (region 110) are dominated by switching losses (i.e., the energy that is required in order to turn-on and turn-off the output bridge), whereas heavy-loaded converters (region 120) are dominated by ohmic losses. A possible way to reduce switching losses for lightly-loaded converters is to decrease the switching activity so that a certain amount of charge is given to the load only when needed. This technique is referred to as pulse skip modulation (or pulse skipping modulation).

An example of pulse skipping modulation is schematically illustrated in FIG. 2, which shows the relationship between the coil current and the load current Iload. As the load current (load gets smaller the coil current becomes negative (row (A)). At this point the amount of charge required by the load can be delivered in a better way: By avoiding negative current through the coil (row (B)) the ripple is reduced along with the losses related to the ripple (e.g., ohmic drops across parasitics of coil and power stage and/or magnetic hysteresis in the coil). In this situation the peak of the current pulses modulates the amount of charge given in each cycle, resulting in the average load current (load. As the latter becomes smaller, there is a point where the losses due to turn-on and off of switches in the converter are higher than the ohmic losses associated with the ripple. At this point, skipping pulses becomes more convenient (row (C)), even if the resulting current has higher peaks (i.e., higher ripple).

However, while using pulse skipping modulation is desirable for lightly-loaded converters, pulse skipping techniques for DC/DC converters with multiple loops (multiple feedback loops) and/or multiple levels (multiple output levels) suffer from high complexity and high area cost.

### SUMMARY

Thus, there is a need for improved switching power converter circuits that use pulse skipping modulation and for corresponding methods of power conversion by such switching power converters. There is further need for such switching power converter circuits and corresponding methods that use improved techniques for making the pulse skip decision.

In view of some or all of these needs, the present disclosure proposes switching power converter circuits for receiving an input power at an input node and outputting an output power at an output node, and methods of power conversion using a switching power conversion circuit, having the features of the respective independent claims.

An aspect of the disclosure relates to a switching power converter circuit for receiving an input voltage at an input node and outputting an output voltage at an output node. The switching power converter circuit may be a DC-DC converter, for example. Also, the switching power converter may be a multi-level and/or multi-loop power converter. The switching power converter circuit may include a power stage with a plurality of switching elements. The switching elements may comprise transistor switches, such as MOSFETs, for example. The switching power converter circuit may further include a feedback loop for generating an error voltage of the switching power converter. The error voltage of the switching power converter may be an error voltage between the output voltage and a reference voltage for the output voltage, for example. The switching power converter circuit may further include a modulator circuit for generating a drive signal for controlling switching operation of the power stage based on the error voltage. The modulator circuit may be a PWM modulator circuit, for example. The drive signals may be PWM signals, for example. The switching power converter circuit may further include a prediction circuit for generating a prediction (e.g., an estimate) of the error voltage based on the input voltage and the output voltage. The prediction of the error voltage may relate to an ideal error voltage at the input voltage and the output voltage. The switching power converter circuit may yet further include a comparison circuit for comparing the prediction of the error voltage to an actual value of the error voltage and for instructing the modulator circuit to enter a pulse skipping mode based on a result of the comparison.

Configured as proposed, the switching power converter circuit requires a single comparator for comparing the actual error voltage to its prediction, regardless of the number of feedback loops. This is the case since the prediction of the error voltage is always close to the dominant error voltage and thus represents an adaptive threshold for the pulse skip decision. As such, the pulse skip decision scheme of the proposed switching power converter circuit is not affected by the number of feedback loops and the number of levels. Moreover, since the threshold is adaptive, the switching power converter circuit can react quickly to load changes after transitions from one of multiple levels to another and overshoot/undershoot of the output voltage can be significantly reduced. In summary, the proposed switching power converter circuit has improved accuracy compared to conventional switching power converter circuits, while also reducing circuit area and cost, especially for multiple feedback loops and/or multiple levels.

In some embodiments, the switching power converter circuit may include a plurality of feedback loops. Each feedback loop may generate a respective error voltage. The switching power converter circuit may further include a minimizer circuit for receiving the plurality of error voltages and outputting a lowest one of the plurality of error voltages. The lowest one of the plurality of error voltages may be provided to the modulator circuit for generating the drive signal and may be provided to the comparison circuit as the actual error voltage for comparison to the prediction of the error voltage.

Since the prediction of the error voltage will always be close to the dominant error voltage (e.g., the smallest error voltage), a single comparator is required for implementing the comparison circuit, regardless of a number of feedback loops of the switching power converter circuit.

In some embodiments, the comparison circuit may instruct the modulator circuit to enter the pulse skipping mode if the actual error voltage is smaller than the prediction of the error voltage. To this end, the comparison circuit may include an analog comparator.

In some embodiments, the comparison circuit may be adapted to apply a hysteresis in the comparison of the prediction of the error voltage to the actual value of the error voltage. Thereby, unnecessary toggling between the pulse skip mode and the normal operation mode can be avoided.

In some embodiments, the power stage may be a multi-level power stage capable of generating multiple levels of the output voltage (i.e., capable of generating the output voltage at multiple levels). In this configuration, the modulator circuit may generate a respective drive signal for each one of the multiple levels. In the proposed configuration the number of levels does not affect the pulse skip decision by the comparison circuit.

In some embodiments, the switching power converter may be a buck-boost converter.

Another aspect of the disclosure relates to a further switching power converter circuit for receiving an input voltage at an input node and outputting an output voltage at an output node. The switching power converter circuit may be a DC-DC converter, for example. Also, the switching power converter may be a multi-level and/or multi-loop power converter. The switching power converter circuit may include a power stage with a plurality of switching elements. The switching power converter circuit may further include a feedback loop for generating an error voltage of the switching power converter. The switching power converter circuit may further include a modulator circuit for generating a drive signal for controlling switching operation of the power stage based on the error voltage. The modulator circuit may be a PWM modulator circuit, for example. The drive signals may be PWM signals, for example. The switching power converter circuit may further include a prediction circuit for generating a prediction (e.g., an estimate) of the drive signal for the power stage based on the input voltage and the output voltage. The prediction of the error voltage may relate to an ideal drive signal at the input voltage and the output voltage. The switching power converter circuit may yet further include a comparison circuit for comparing the prediction of the drive signal to the actual drive signal and for instructing the modulator circuit to enter a pulse skipping mode based on a result of the comparison.

Configured as proposed, the switching power converter circuit requires a single comparator for comparing the actual (i.e., active) drive signal to the prediction of the drive signal, regardless of the number of levels. This is the case since the prediction of the drive signal is always close to the respective active drive signal and thus represents an adaptive threshold for the pulse skip decision. As such, the pulse skip decision scheme of the proposed switching power converter circuit is not affected by the number of feedback loops and the number of levels. Moreover, since the threshold is adaptive, the switching power converter circuit can react quickly to load changes after transitions from one of multiple levels to another and overshoot/undershoot of the output voltage can be significantly reduced. In summary, the proposed switching power converter circuit has improved accuracy compared to conventional switching power converter circuits, while also reducing circuit area and cost, especially for multiple feedback loops and/or multiple levels.

In some embodiments, the switching power converter circuit may include a plurality of feedback loops, each feedback loop generating a respective error voltage. The switching power converter circuit may further include a minimizer circuit for receiving the plurality of error voltages and outputting a lowest one of the plurality of error voltages. Then, the lowest one of the plurality of error voltages may be provided to the modulator circuit for generating the drive signal. In the proposed configuration the number of feedback loops does not affect the pulse skip decision by the comparison circuit.

In some embodiments, the comparison circuit may instruct the modulator circuit to enter the pulse skipping mode if a duty cycle of the actual drive signal is smaller than the duty cycle of the prediction of the drive signal. To this end, the comparison circuit may include a phase detector.

In some embodiments, the comparison circuit may be adapted to apply a hysteresis in the comparison of the prediction of the drive signal to the actual drive signal. Thereby, unnecessary toggling between the pulse skip mode and the normal operation mode can be avoided.

In some embodiments, the power stage may be a multi-level power stage capable of generating multiple levels of the output voltage (i.e., capable of generating the output voltage at multiple levels). In this configuration, the modulator circuit may generate a respective drive signal for each one of the multiple levels. Moreover, the comparison circuit may compare, at each time, that drive signal that is currently active (e.g., that currently toggles between high and low) to the prediction for the drive signal. In other words, the active drive signal may be used as the actual drive signal. Since the predicted drive signal will always be close to the active drive signal, the predicted drive signal is sufficient as a threshold for the pulse skip decision regardless of a number of levels of the switching power converter circuit.

In some embodiments, the switching power converter may be a buck-boost converter.

Another aspect of the disclosure relates to a method of power conversion using a switching power converter circuit that receives an input voltage at an input node and outputs an output voltage at an output node. The power converter circuit may include a power stage with a plurality of switching elements. The method may include generating an error voltage of the switching power converter circuit using a feedback loop. The method may further include generating a drive signal for controlling switching operation of the power stage based on the error voltage. The method may further include generating a prediction of the error voltage based on the input voltage and the output voltage. The method may yet further include comparing the prediction of the error voltage to an actual value of the error voltage and entering a pulse skipping mode based on a result of the comparison.

In some embodiments, the method may include generating, using a plurality of feedback loops, a plurality of respective error voltages. The method may further include determining a lowest one of the plurality of error voltages. The method may further include using the lowest one of the plurality of error voltages for generating the drive signal. The method may yet further include comparing the lowest one of the plurality of error voltages, as the actual error voltage, to the prediction of the error voltage.

In some embodiments, the method may include entering the pulse skipping mode if the actual error voltage is smaller than the prediction of the error voltage.

In some embodiments, the method may include applying a hysteresis in the comparison of the prediction of the error voltage to the actual value of the error voltage.

In some embodiments, the comparison may be performed using a comparison circuit that comprises an analog comparator.

In some embodiments, the power stage of the switching power converter circuit may be multi-level power stage capable of generating multiple levels of the output voltage. Then, the method may include generating a respective drive signal for each one of the multiple levels.

In some embodiments, the switching power converter may be a buck-boost converter.

Another aspect of the disclosure relates to a further method of power conversion using a switching power converter circuit that receives an input voltage at an input node and outputs an output voltage at an output node. The power converter circuit may include a power stage with a plurality of switching elements. The method may include generating an error voltage of the switching power converter circuit using a feedback loop. The method may further include generating a drive signal for controlling switching operation of the power stage based on the error voltage. The method may further include generating a prediction of the drive signal for the power stage based on the input voltage and the output voltage. The method may yet further include comparing the prediction of the drive signal to the actual drive signal and entering a pulse skipping mode based on a result of the comparison.

In some embodiments, the method may include generating, using a plurality of feedback loops, a plurality of respective error voltages. The method may further include determining a lowest one of the plurality of error voltages. The method may yet further include using the lowest one of the plurality of error voltages for generating the drive signal.

In some embodiments, the method may include entering the pulse skipping mode if a duty cycle of the actual drive signal is smaller than the duty cycle of the prediction of the drive signal.

In some embodiments, the method may include applying a hysteresis in the comparison of the prediction of the drive signal to the actual drive signal.

In some embodiments, the comparison may be performed using a comparison circuit that comprises a phase detector.

In some embodiments, the power stage of the switching power converter circuit may be a multi-level power stage capable of generating multiple levels of the output voltage. Then, the method may include generating a respective drive signal for each one of the multiple levels. The method may further include comparing, at each time, that drive signal that is currently active to the prediction for the drive signal.

In some embodiments, the switching power converter may be a buck-boost converter.

It will be appreciated that method steps and apparatus features may be interchanged in many ways. In particular, the details of the disclosed method can be implemented as an apparatus adapted to execute some or all or the steps of the method, and vice versa, as the skilled person will appreciate. In particular, it is understood that methods according to the disclosure relate to methods of operating the circuits according to the above embodiments and variations thereof, and that respective statements made with regard to the circuits likewise apply to the corresponding methods.

It is also understood that in the present document, the term “couple” or “coupled” refers to elements being in electrical communication with each other, whether directly connected e.g., via wires, or in some other manner (e.g., indirectly). Notably, one example of being coupled is being connected.

### BRIEF DESCRIPTION OF THE DRAWINGS

Example embodiments of the disclosure are explained below with reference to the accompanying drawings, wherein like reference numbers indicate like or similar elements, and wherein

FIG. 1 schematically illustrates an example of a relationship between an efficiency and a load current of a switching power converter circuit,

FIG. 2 schematically illustrates examples of relationships between a coil current and a load current for a switching power converter circuit,

FIG. 3 schematically illustrates an example of a switching power converter circuit that uses pulse skipping modulation,

FIG. 4 schematically illustrates an example of a pulse skipping decision for the switching power converter circuit of FIG. 3,

FIG. 5 schematically illustrates an example of another switching power converter circuit that uses pulse skipping modulation,

FIG. 6 schematically illustrates an example of a pulse skipping decision for the switching power converter circuit of FIG. 5,

FIG. 7 schematically illustrates an example of a multi-loop switching power converter circuit that uses pulse skipping modulation,

FIG. 8 schematically illustrates an example of a power stage of a three-level switching power converter circuit,

FIG. 9 schematically illustrates an example of a power stage of a buck-boost power converter circuit,

FIG. 10 schematically illustrates an example of generating PWM drive signals for the buck stage and the boost stage in the buck-boost power converter circuit of FIG. 9,

FIG. 11 schematically illustrates an example of a relationship between a dominant voltage error and threshold voltages for entering the pulse skipping mode in the buck-boost power converter circuit of FIG. 9,

FIG. 12 schematically illustrates an example of a switching power converter circuit according to embodiments of the disclosure,

FIG. 13 schematically illustrates an example of a pulse skipping decision for the switching power converter circuit of FIG. 12 according to embodiments of the disclosure,

FIG. 14 schematically illustrates an example of a prediction circuit for switching power converter circuits according to embodiments of the disclosure, and

FIG. 15 schematically illustrates examples of waveforms in the prediction circuit of FIG. 14.

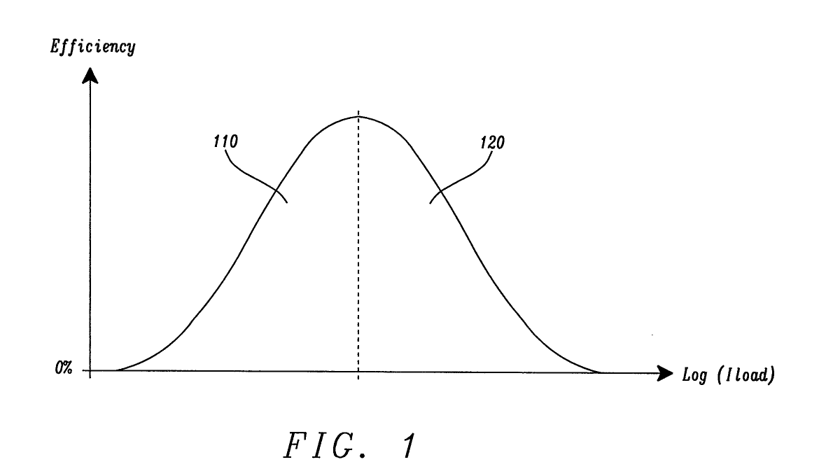

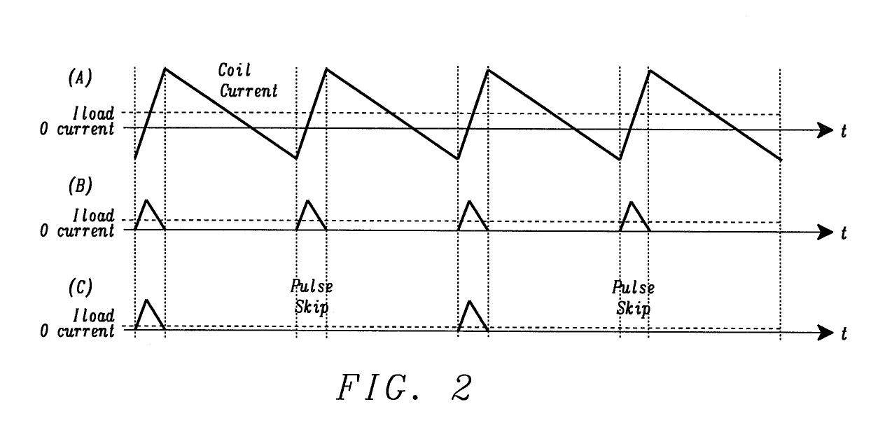

### DESCRIPTION

As indicated above, identical or like reference numbers in the disclosure indicate identical or like elements, and repeated description thereof may be omitted for reasons of conciseness.

In principle, a system that uses pulse skip modulation can make the skip decision in different ways: (1) output voltage (Vout)-based pulse skip, (2) error voltage (Verr)-based pulse skip, or (3) duty-based pulse skip. These techniques will be described in turn below.

(1) Output Voltage (Vout)-Based Pulse Skip

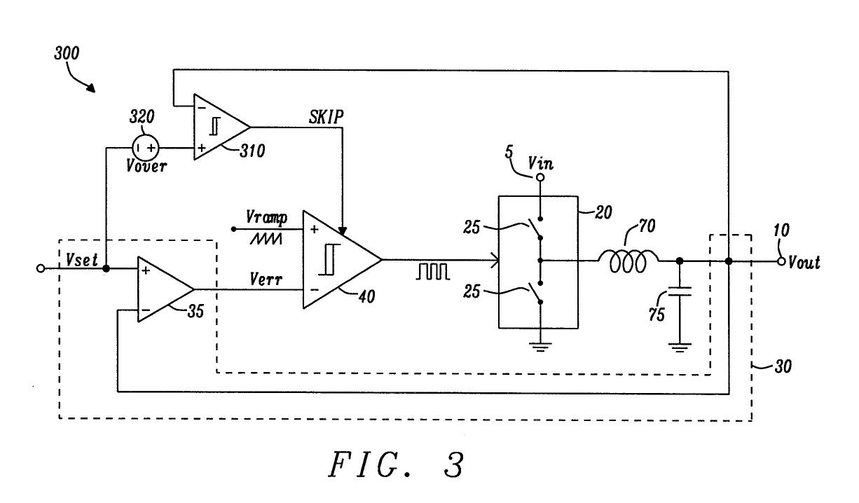

An example of a switching power converter 300 in which the decision on pulse skipping is taken based on the output voltage Vout is schematically illustrated in FIG. 3. The switching power converter circuit 300 receives an input voltage Vin at an input node 5 and outputs the output voltage Vout at an output node 10. To this end, the switching power converter circuit 300 comprises a power stage 20 that in turn comprises a plurality of switching elements 25 (switches, e.g., transistor switches, such as MOSFETs). The plurality of switching elements 25 can be coupled in series between the input node 5 and ground. The output node 10 can be coupled to the power stage 20 via an LC circuit comprising an output inductor (coil) 70 and an output capacitor 75. The switching power converter circuit 300 further comprises a modulator circuit 40 (e.g., PWM modulator) that generates a drive signal (e.g., PWM signal (Duty)) for controlling a switching operation of the power stage 20. The modulator circuit 40 generates the drive signal based on an error voltage that is generated/output by a feedback loop 30. In the example of FIG. 3, the feedback loop 30 generates the error voltage based on the output voltage Vout and a reference voltage Vset of the switching power converter circuit 300. To this end, the feedback loop 30 comprises an error amplifier 35 that receives the output voltage Vout at its inverting input and compares the output voltage Vout to the reference voltage Vset, which is received at the non-inverting input of the error amplifier 35. The error amplifier 35 generates and outputs the error voltage Verr based on a result of the comparison. The error voltage Verr is then provided to the modulator circuit 40 for comparison to a ramp voltage Vramp and the drive signal is generated and output based on a result of the comparison.

The switching power converter circuit 300 further comprises a voltage comparator 310 that takes the output voltage Vout and the reference voltage Vset as inputs (e.g., at its inverting and non-inverting inputs, respectively). The voltage comparator 310 trips (and instructs the modulator circuit 40 to enter the pulse skipping mode, e.g., via a SKIP signal) when the output voltage Vout equals the reference voltage Vset plus a certain offset (Vover). The offset Vover may be generated by a voltage source 320 that is coupled between the reference voltage Vset and the voltage comparator 310 (e.g., to the non-inverting input of the voltage comparator 310).

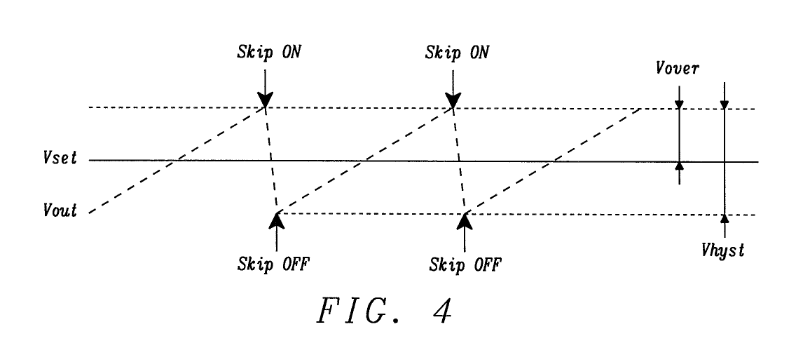

This pulse skipping decision is also illustrated in FIG. 4. When Vout=Vset+Vover (i.e., when the output voltage Vout rises to the reference voltage Vset plus the offset voltage Vover), the switching power converter circuit 300 starts to skip (Skip ON). It exits from pulse skipping mode (Skip OFF) when Vout=Vset+Vover−Vhyst (i.e., when the output voltage Vout drops to the reference voltage Vset plus the offset voltage Vover minus the hysteresis voltage Vhyst), wherein applying the hysteresis voltage Vhyst is optional.

(2) Error Voltage (Verr)-Based Pulse Skip

An example of a switching power converter 500 in which the decision on pulse skipping is taken based on the error voltage Verr is schematically illustrated in

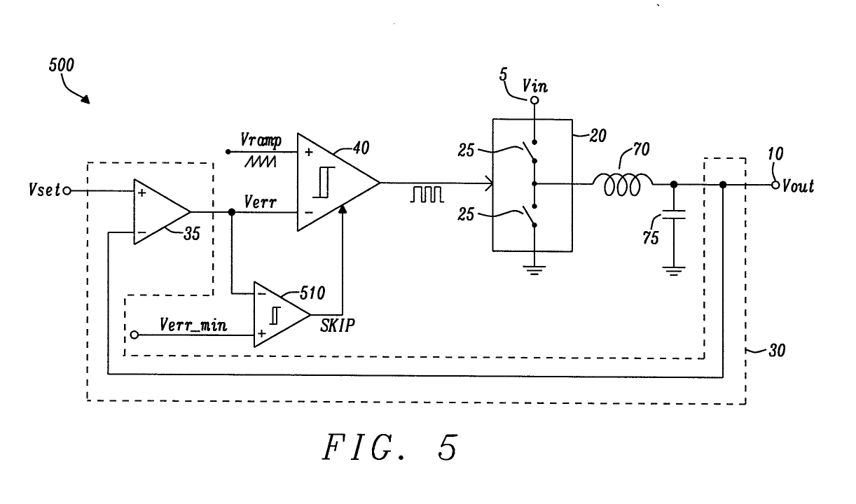

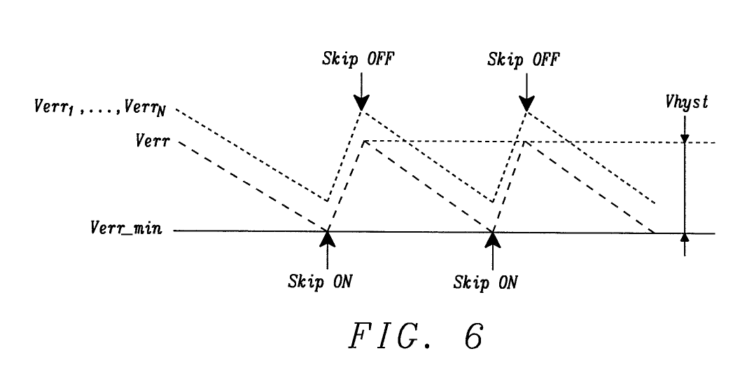

FIG. 5. The switching power converter circuit 500 differs from the switching power converter circuit 300 in FIG. 3 in that the voltage comparator 310 is replaced by a voltage comparator 510 that takes the error voltage Verr and a fixed reference voltage Verr_min that sets the minimum value for the error voltage Verr as inputs (e.g., at its inverting and non-inverting inputs, respectively). The voltage comparator 510 trips (and instructs the modulator circuit 0 to enter the pulse skipping mode, e.g., via a SKIP signal) when the error voltage Verr equals the reference voltage Verr_min. This pulse skipping decision is also illustrated in FIG. 6. When Verr=Verr_min (i.e., when the error voltage Verr drops to the reference voltage Verr_min), the switching power converter circuit 500 starts to skip (Skip ON). It exits from pulse skipping mode (Skip OFF) when Verr=Verr_min+Vhyst (i.e., when the error voltage Verr rises to the reference voltage Verr_min plus the hysteresis voltage Vhyst), wherein applying the hysteresis voltage Vhyst is optional. When there is more than one error voltage (e.g., error voltages Verr and Verr₁, . . . , Verr_{N} in FIG. 6), the lowest error voltage can be considered as the dominant error voltage. The lowest error voltage can be isolated using an (analog) minimizer circuit, for example.

(3) Duty-Based Pulse Skip

Further, the pulse skipping decision may be made by setting a minimum value for the duty cycle (D) of the switching power converter circuit and start skipping if the duty cycle D drops to this minimum value. This method is very similar to the Verr-based approach (2) since there is a direct relationship between the duty cycle D and the (dominant) error voltage Verr. One difference may be in the way the duty cycle D and the error voltage Verr are compared to their respective minimum values, for example in the digital and analog domains, respectively.

Pulse skipping is often applied in multi-loop and/or multi-level architectures of switching power converts. However, the above techniques for making the pulse skip decision have limited applicability to multi-loop and/or multi-level architectures. Non-limiting examples of multi-loop and multi-level architectures will be described below.

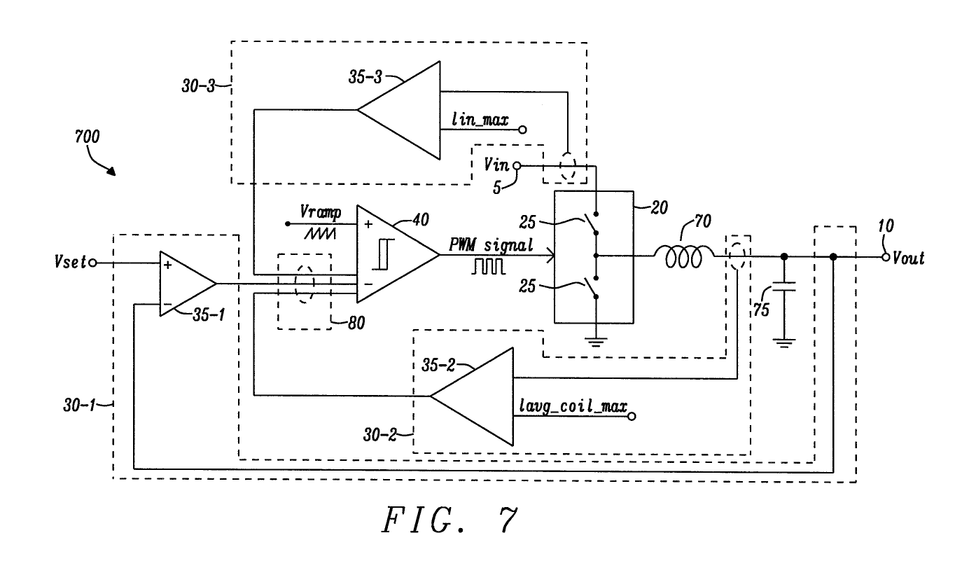

FIG. 7 schematically illustrates an example of a switching power converter circuit 700 with three (feedback) loops. The switching power converter circuit 700 comprises a first feedback loop 30-1 (voltage loop) that regulates the output voltage Vout at a given reference voltage Vset, a second feedback loop 30-2 that limits the current that flows though the inductor (e.g., a Coil AVG Current Limiter), and a third feedback loop 30-3 that limits the current supplied by the input voltage of the converter Vin (e.g., an Input Current Limiter).

All the feedback loops can be described with an error voltage Verr that is the result of a comparison between a measured quantity and a reference value. Multi-loops can coexist as only one of them regulates the duty-cycle of the power stage at a given time. Usually, this is the loop with the smallest error voltage Verr. To this end, the switching power converter circuit 700 may comprise a minimizer circuit 80 for receiving the plurality of error voltages and outputting a lowest one of the plurality of error voltages, for example. The lowest error voltage at each given timing may be referred to as the dominant error voltage at that timing.

The first feedback loop 30-1 generates a first error voltage Verr₁ based on the output voltage Vout and a reference voltage Vset of the switching power converter circuit 700. To this end, the first feedback loop 30-1 comprises a first error amplifier 35-1 that receives the output voltage Vout at its inverting input and compares the output voltage Vout to the reference voltage Vset, which is received at the non-inverting input of the first error amplifier 35-1. The first error amplifier 35-1 generates and outputs the first error voltage Verr₁ based on a result of the comparison. The second feedback loop 30-2 generates a second error voltage Verr₂ based on an indication of an average inductor current (e.g., a voltage proportional to the average inductor current) and a reference for the average inductor current (e.g., a reference voltage proportional to a maximum average inductor current lavg_coil_max). To this end, the second feedback loop 30-2 comprises a second error amplifier 35-2 that receives the indication of the average inductor current and the reference for the average inductor current as inputs and generates and outputs the second error voltage Verr₂ based on a result of the comparison. The third feedback loop 30-3 generates a third error voltage Verr₃ based on an indication of the input current that flows into the input node 5 (e.g., a voltage proportional to the input current) and a reference for the input current (e.g., a reference voltage proportional to a maximum input current lin_max). To this end, the third feedback loop 30-3 comprises a third error amplifier 35-3 that receives the indication of the input current and the reference for the input current as inputs and generates and outputs the third error voltage Verr₃ based on a result of the comparison.

The first, second, and third error voltages Verr₁, Verr₂, Verr₃ are provided to the modulator circuit 40 for comparison to a ramp voltage Vramp and the drive signal is generated and output based on a result of the comparison. As noted above, the comparison to the ramp voltage Vramp may use the dominant error voltage.

Switching power converter circuits according to embodiments of the disclosure (as described in detail below) may comprise any, some, or all of these feedback loops. switching power converter circuits according to embodiments of the disclosure may further comprise a minimizer circuit (e.g., an analog minimizer circuit).

Apart from these feedback loops, the switching power converter circuit 700 further comprises an input node 5, an output node 10, a power stage 20 with a plurality of switching elements 25 (switches, e.g., transistor switches), an output inductor (coil) 70, an output capacitor 75, and a modulator circuit 40 (e.g., PWM modulator). These elements have the same function and purpose as respective like-numbered elements in the switching power converter circuit 300 of FIG. 3.

The modulator circuit 40 generates a drive signal (e.g., PWM signal (Duty)) for controlling a switching operation of the power stage 20. The modulator circuit 40 may generate the drive signal based on a dominant error voltage among the multiple error voltages that are generated/output by the feedback loops. As noted above, the dominant error voltage at each timing may be the smallest error voltage at that timing.

FIG. 8 schematically illustrates an example of an output stage 800 of a switching power converter circuit with three levels. The modulator circuit and any feedback loops are omitted in FIG. 8. The output stage 800 comprises a power stage with a plurality of switching elements 25, viz., first to fourth switching elements S1, S2, S3, and S4 that are coupled in series between the input node 5 and ground. A capacitor 810 is coupled in parallel to the second switching element S2 and the third switching element S3. The output stage 800 further comprises an output LC circuit with an output inductor 70 and an output capacitor 75. The output LC circuit is coupled to an intermediate node between the second switching element S2 and the third switching element S3. The output inductor 70 is coupled between the power stage and the output node 10, and the output capacitor 75 is coupled between the output node 10 and ground.

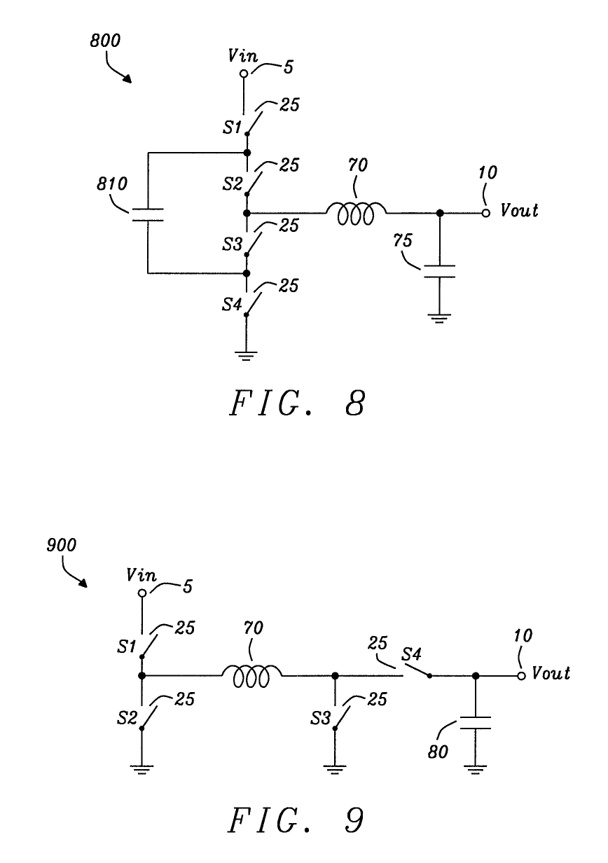

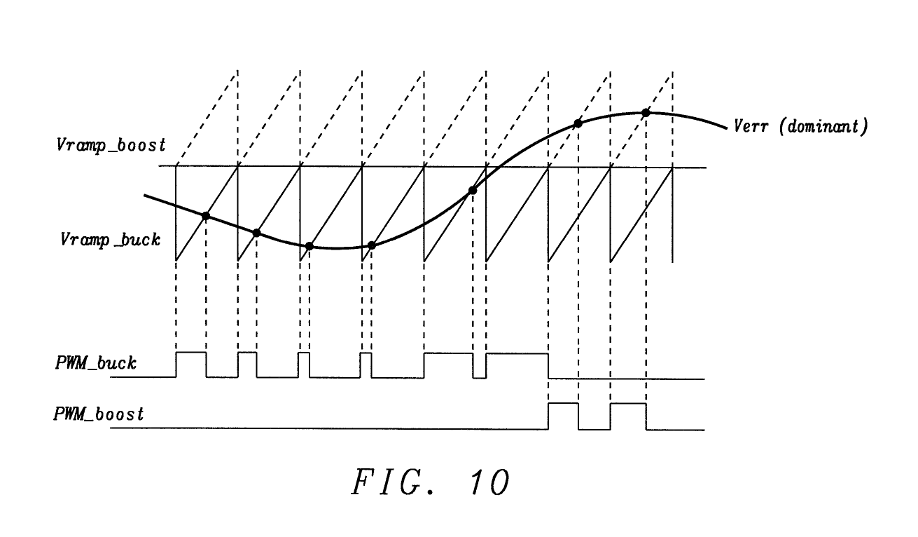

FIG. 9 schematically illustrates an example of an output stage 900 of a buck-boost converter (as an example of a two-level switching power converter circuit). The modulator circuit and any feedback loops are omitted in FIG. 9. The output stage 900 comprises a power stage with a plurality of switching elements 25, viz., first to fourth switching elements S1, S2, S3, and S4. The first and second switching elements S1 and S2 are coupled in series between the input node 5 and ground. The output stage 900 further comprises an output LC circuit with an output inductor 70 and an output capacitor 75. One end of the output inductor 70 is coupled to an intermediate node between the first switching element S1 and the second switching element S2. The other end of the output inductor 70 is switchably coupled to ground via the third switching element S3 and is switchably coupled to the output node 10 via the fourth switching element S4. The output capacitor 75 is coupled between the output node 10 and ground.

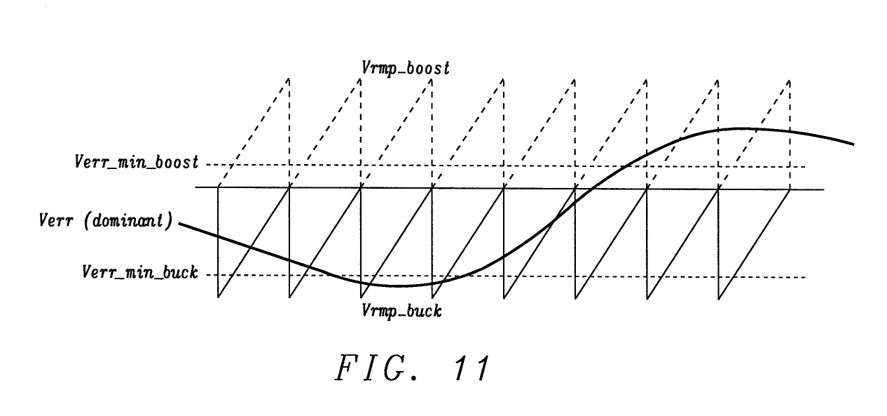

Driving techniques for the abovementioned multi-level architectures are rather similar to each other in that the driving technique for the buck-boost converter can be readily extended to the three-level converter. Thus, the case of the buck-boost converter will be described as an example, without intended limitation. Switching elements S1, S2, S3, S4 are driven by two PWM signals that are generated based on respective comparisons between the dominant error voltage Verr and two triangular waveforms: Vramp_buck and Vramp_boost. An example of a relationship between the dominant error voltage Verr and the two triangular waveforms is schematically illustrated in FIG. 10. If the dominant error voltage Verr is between the minimum and maximum values of the triangular waveform Vramp_boost for boost operation of the buck-boost converter, the PWM signal PWM_boost for boost operation is active and toggles between the high level (e.g., 1) and the low level (e.g., 0), while the PWM signal PWM_buck for buck operation is constant (e.g., at the low level). On the other hand, if the dominant error voltage Verr is between the minimum and maximum values of the triangular waveform Vramp_buck for buck operation of the buck-boost converter, the PWM signal for buck operation is active and toggles between the high level and the low level, while the PWM signal for boost operation is constant (e.g., at the low level). The actual switching scheme of the first to fourth switching elements

S1, S2, S3, S4 is given in the following table:

TABLE
buck-boost driving scheme

| PWM_buck = 1 | PWM_boost = 0 |
|---|---|
| S1, S4: ON | S1, S4: ON |
| S2, S3: OFF | S2, S3: OFF |
| PWM_buck = 0 | PWM_boost = 1 |
| S2, S4: ON | S1, S3: ON |
| S1, S3: OFF | S2, S4: OFF |

Next, advantages and disadvantages of the pulse skipping approaches (1), (2), and (3) when used in the context of multi-loop and/or multi-level architectures will be described.

(1) Output Voltage (Vout)-Based Pulse Skip

Vout-based pulse skip can be used in multi-level architectures because the sensed voltages are level-independent. On the other hand, in a DC/DC converter with N control loops (see, e.g., FIG. 7, where N=3), N comparators are needed. Furthermore, not all the loops can be easily descripted in a “Vout and Vset” fashion, especially the ones that sense a current instead of a voltage. Moreover, delicate matching between error amplifier and comparator is required since process variations in quantities like Vover, Vhyst, and Vset can cause the system to not work properly.

(2) Error Voltage (Verr)-Based Pulse Skip

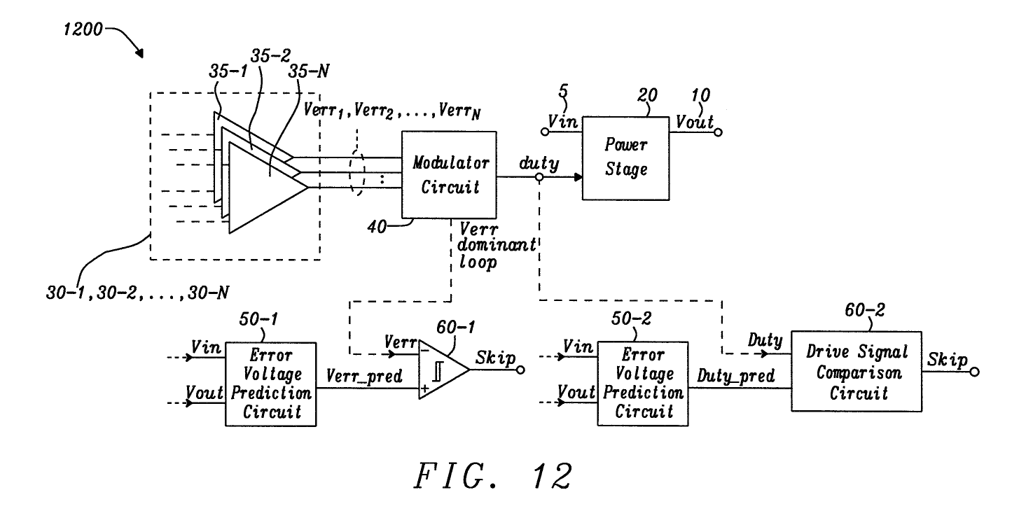

When using Verr-based pulse skip a DC/DC converter with N control loops requires only one comparator since there is only one dominant Verr at a given time (e.g., the smallest one). Taking the decision with amplified signals (e.g., outputs of the error amplifiers) increases the accuracy. On the other hand, Verr-based pulse skip is not convenient for multi-level DC/DC converters, buck-boost converters, and SIMO MISO and MIMO systems since there is no unique minimum voltage value Verr_min for the error voltage Verr for making the pulse skip decision. This is schematically illustrated in the example of FIG. 11, in which one minimum voltage value Verr_min_buck for the error voltage Verr in buck operation (buck mode) and one minimum voltage value Verr_min_boost for the error voltage Verr in boost operation (boost mode) are necessary. In general, the Verr-based pulse skip decision requires one comparator per level, as well as information on the applicable mode/status (e.g., the current level).

(3) Duty-Based Pulse Skip

Advantages and disadvantages for duty-based pulse skip are the same as for Verr-based pulse skip.

Given the above disadvantages, it may be possible to implement a DC/DC converter (as an example of a switching power converter circuit) that utilizes both multi-loop and multi-level architectures, but doing so can be a very demanding in terms of circuit complexity and circuit area.

Namely, for multi-loop DC/DC converters Vout-based pulse skip readily supports multi-level architectures but becomes problematic for multi-loop architectures. The reasons is that it requires a comparator for each loop and specialized solutions when loops cannot immediately be described in terms of Vout and Vset. Also, the circuit area increases with the number of loops.

Moreover, for multi-level DC/DC converters Verr/Duty-based pulse skip readily support multi-loop architectures but become problematic for multi-level architectures. In this case, one comparator must be provided per level and information on the actual level in which the comparator is working is additionally needed. Circuit area and circuit complexity increase with the number of levels.

In view of the above disadvantages, the present disclosure seeks to provide a technique for pulse skip that can be utilized as is without having to care for an increase of either the number of levels or loops.

Broadly speaking, the present disclosure presents a switching power converter circuit with a system that calculates the ideal Duty (D) or ideal error voltage (Verr) of the switching power converter circuit for a given combination of the input voltage Vin and the output voltage Vout, and with a phase detector (e.g. mutext) or an analog comparator. Core of the underlying idea is to compare the predicted Duty or predicted error voltage with the actual Duty or error voltage Verr, respectively, to decide whether or not to skip the next 1× pulse. In some implementations, this will result in a multi-loop and/or multi-level DC/DC converter that enters the skip mode with a variable threshold for the duty cycle.

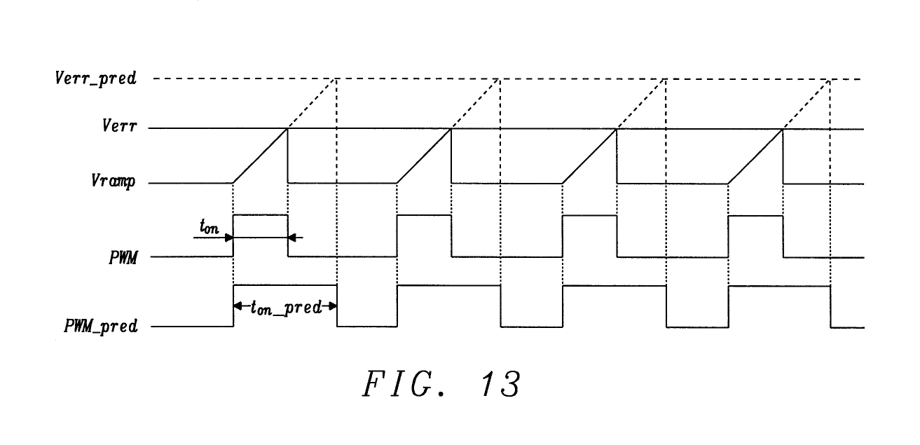

An example of a switching power converter circuit 1200 according to embodiments of the disclosure is schematically illustrated in FIG. 12. In this schematic illustration any feedback loops are omitted for reasons of conciseness. It is noted however that the switching power converter circuit 1200 can comprise any number of feedback loops, including, but no limited to, some, any, or all of the feedback loops described above with reference to FIG. 7. Notably, the switching power converter circuit 1200 may be a buck-boost converter, for example.

The modulator circuit 40 receives one or more error voltages Verr₁, Verr₂, . . . , Verr_{N} from corresponding feedback loops 30-1, 30-2, . . . , 30-N and generates a drive signal (or multiple drive signals, if the switching power converter circuit uses a multi-level architecture, e.g., one drive signal per level) for the power stage 20 based on the error voltages. For example the modulator circuit may generate the drive signal(s) based on the dominant error voltage, which may be the smallest error voltage. To this end, the switching power converter circuit 1200 may comprise a minimizer circuit for receiving plural error voltages and isolating and outputting a smallest one of the error voltages (at each point in time). Then, (only) the dominant (e.g., lowest) error voltage will be provided to the modulator circuit 40.

The switching power converter circuit 1200 further comprises a prediction circuit 50-1 (error voltage prediction circuit) for generating a prediction Verr_pred of the (dominant) error voltage. This prediction may relate to an estimate of an ideal error voltage (e.g., at the present input voltage Vin and the present output voltage Vout). Alternatively or additionally, the switching power converter circuit 1200 comprises a prediction circuit 50-2 (drive signal prediction circuit) for generating a prediction Duty_pred of the drive signal for the power stage 20. This prediction may relate to an estimate of an ideal drive signal (e.g., at the present input voltage Vin and the present output voltage Vout).

Notably, although FIG. 12 shows both prediction circuits 50-1, 50-2, the present disclosure also relates to implementations in which the switching power converter circuit comprises either (but not both) of the prediction circuits 50-1, 50-2. In other words, depending on the case the switching power converter circuit can either use prediction of Verr or Duty as they both carry the information needed for making an appropriate pulse skip decision.

Both prediction circuits 50-1, 50-2 generate their respective prediction based on the input voltage Vin and the output voltage Vout of the switching power converter circuit 1200. To this end, the input voltage Vin and the output voltage Vout are fed to the prediction circuits 50-1, 50-2 as inputs.

is For the case of the switching power converter circuit 1200 comprising the error voltage prediction circuit 50-1, the prediction Verr_pred of the error voltage and the actual error voltage Verr are provided to a comparison circuit 60-1 (error voltage comparison circuit) for comparing the prediction Verr_pred of the error voltage to the actual value of the error voltage Verr. To this end, the error voltage comparison circuit 60-1 may comprise an analog comparator. Also, the error voltage comparison circuit 60-1 may apply a hysteresis in the comparison.

In the case of a multi-loop architecture, the dominant (e.g., smallest) error voltage may be provided to the error voltage comparison circuit 60-1 for comparison to the prediction Verr_pred of the error voltage. For example, the minimizer circuit mentioned above may provide its output to the error voltage comparison circuit 60-1 as the actual error voltage Verr for being compared to the prediction Verr_pred of the error voltage.

The error voltage comparison circuit 60-1 instructs the modulator circuit 40 to enter the pulse skip mode (e.g., to skip the next 1× pulse) depending on a result of the comparison. For example, the error voltage comparison circuit 60-1 may decide that the pulse skip mode should be entered (and may instruct the modulator circuit 40 accordingly, e.g., via a pulse skip signal) if the actual error voltage Verr is smaller than the predicted error voltage Verr_pred, i.e.,

Verr<Verr_pred→skip

If the error voltage comparison circuit 60-1 applies a hysteresis, the modulator circuit 40 may be instructed to end pulse skipping if the actual error voltage Verr exceeds the prediction Verr_pred of the error voltage by some margin. Otherwise, without hysteresis, the modulator circuit 40 would be instructed to end pulse skipping if the actual error voltage Verr rises above the prediction Verr_pred of the error voltage.

For the case of the switching power converter circuit 1200 comprising the drive signal prediction circuit 50-2, the prediction of the drive signal Duty_pred and the actual drive signal Duty are provided to a comparison circuit 60-2 (drive signal comparison circuit) for comparing the prediction Duty_pred of the drive signal to the actual drive signal Duty. To this end, the drive signal comparison circuit 60-2 may comprise a phase detector. Also, the drive signal comparison circuit 60-2 may apply a hysteresis in the comparison.

In the case of a multi-level architecture, the respective active drive signal (e.g., the drive signal that is currently toggling) may be used by the drive signal comparison circuit 60-2 for comparison to the prediction Duty_pred of the drive signal. In some embodiments, only the active drive signal may be provided to the drive signal comparison circuit 60-2.

The drive signal comparison circuit 60-2 instructs the modulator circuit 40 to enter the pulse skip mode (e.g., to skip the next 1× pulse) depending on a result of the comparison. For example, the drive signal comparison circuit 60-2 may decide that the pulse skip mode should be entered (and may instruct the modulator circuit 40 accordingly, e.g., via a pulse skip signal) if the on-time tₒₙ of the actual drive signal Duty is smaller than the (predicted) on-time tₒₙ_{_}pred of the predicted drive signal Duty, i.e.,

tₒₙ<tₒₙ_{_}pred→skip

In other words, the drive signal comparison circuit 60-2 may decide that the pulse skip mode should be entered (and may instruct the modulator circuit 40 accordingly, e.g., via a pulse skip signal) if the duty cycle of the actual drive signal Duty is smaller than the (predicted) duty cycle of the predicted drive signal Duty.

If the drive signal comparison circuit 60-2 applies a hysteresis, the modulator circuit 40 may be instructed to end pulse skipping if the on-time tₒₙ of the actual drive signal Duty exceeds the on-time t_{on—}pred of the predicted drive signal Duty by some margin. Otherwise, without hysteresis, the modulator circuit 40 would be instructed to end pulse skipping if the on-time tₒₙ of the actual drive signal Duty rises above the on-time t_{on—}pred of the predicted drive signal Duty.

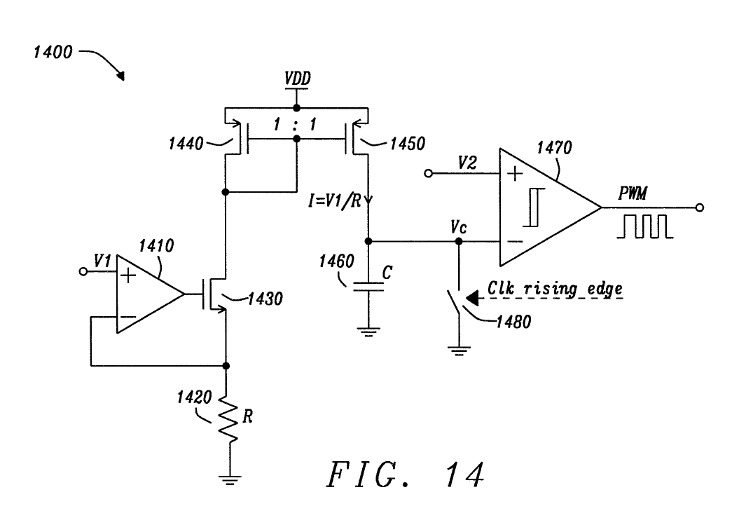

FIG. 13 schematically illustrates the pulse skip decision based on the comparison of predicted and actual drive signals. In particular, FIG. 13 illustrates a case in which it is decided to perform pulse skipping.

Since the modulator circuit (e.g., PWM modulator), which has the ramp voltage Vramp and the error voltages Verr₁, . . . , Verr_{N} of respective feedback loops as inputs, automatically selects the dominant error voltage, the above control scheme for pulse skip decisions can work in a multi-loop architecture with an arbitrary number of loops using a single comparator.

There is also no limitation on the number of levels as the skip thresholds for the error voltage Verr or the drive signal Duty (i.e., the predictions for the error voltage or the drive signal, Verr_pred or Duty_pred) dynamically follow the status of the system. Therefore, it is not necessary to have a comparator per level and it is not necessary to have available information on the current status of the switching power converter circuit.

Next, techniques for predicting or estimating Duty or Verr will be described.

The idea behind Duty/Verr prediction is that there is a univocal relationship between the input/output voltage ratio of a converter and the duty cycle used to obtain it. There are several approaches that one can follow in order to obtain such information. For the sake of conciseness, the example of a buck converter will be considered. A buck converter has the following well known relationship between Vin and Vout:

Duty cycle=Vout/Vin

To a first approximation, the Duty cycle of the considered converter can be calculated (neglecting the finite output impedance that makes the relationship a function of the output load, and other second order effects):
(i) via an analog divider that takes Vout and Vin as inputs,
(ii) via a digital divider that takes a digitalized version of Vout and Vin as inputs (Vout can be substituted with Vset, a voltage that in many applications already comes from the digital domain), or
(iii) via an analog block that emulates the behavior of the buck converter.

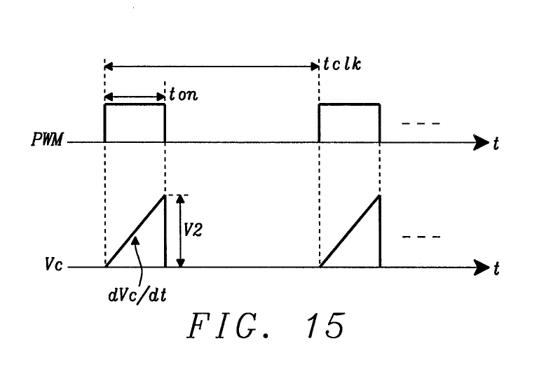

Depending on the situation, each of techniques (i), (ii), and (iii) can be used for predicting Verr and/or Duty. Techniques (i) and (ii) are quite intuitive approaches. A more detailed example of technique (iii) will be described next with reference to FIG. 14 and FIG. 15.

FIG. 14 schematically illustrates an example of a Duty predictor circuit 1400. A current I proportional to a first voltage V1 and inversely proportional to a resistance R, 1420, (I=V1/R) is fed into a capacitor C, 1460. This current I may be generated by a current mirror comprising two gate-coupled transistors 1440, 1450 with mirror ratio 1:1. The transistor 1440 on the input side of the current mirror is coupled to ground via the resistance R. A voltage across the resistance R is controlled to equal the first voltage V1 by a feedback loop involving an error amplifier 1410 and a feedback controlled transistor element 1430. The voltage Vc across the capacitor C is then compared to a second voltage V2 at a comparator 1470 that outputs a PWM signal. As long as the voltage Vc across the capacitor C is smaller than the second voltage V2, Vc<V2, the high level (e.g., 1) of the PWM signal will be output. The comparator 1470 trips (and outputs the low level (e.g., 0) of the PWM signal) when the voltage Vc across the capacitor C reaches the second voltage, Vc=V2. The capacitor C is then discharged through a switch 1480 at the rising edge of the next clock cycle and the PWM signal returns to the high level (e.g., 1).

FIG. 15 schematically illustrates an example of the relationship between the voltage Vc across the capacitor C and the PWM signal. The voltage Vc across the capacitor C satisfies the following relations:Error! Reference source not found.

ΔVc/Δt=I/C=V1/(RC)

and

ΔVc=V2

Δt=ton

If the product RC is chosen to be the same as the time between one rising edge of the clock signal and the next, tclk, we have

V2=V1 (ton/tclk)=V1·Duty

The first and second voltages V1 and V2 can be chosen to be correspond to the input voltage Vin and the output voltage Vout, respectively.

Next, a summary of technical effects of switching power converter circuits according to embodiments of the disclosure will be provided.

First, a lightly-loaded (e.g., 5 mA) multi-level system (e.g., buck-boost) where the Verr-based Pulse Skipping is used will be considered. Initially the system is assumed to be skipping in buck mode (with a low Verr that stays between a Verr_min_buck and a Verr_min_buck+Vhyst). When the input voltage Vin becomes smaller than the output voltage Vout, the system enters the boost mode and the status comparator trips (notably, this comparator is not needed if predictor-based approaches according to embodiments of the disclosure are used). At this point the error voltage Verr rises as the system needs to be driven in boost mode, but during its whole settling time the error voltage stays below the new boost skip threshold

(Verr_min_boost). Even if Vout is collapsing the system cannot do anything as it is forced to skip pulses. Thus, undershoots of the output voltage Vout occur and so do overshoots during the opposite transition (boost-to-buck).

In the other hand, using a predictor-based pulse skipping technique according to embodiments of the disclosure, the transition from buck to boost (or vice versa) is smoother as the prediction Verr_pred for the error voltage is always close to the dominant error voltage Verr and the skip threshold adjusts dynamically. The system can exit pulse skipping with no latency, resulting in a better regulation of Vout and significant decrease of undershoot (or overshoot for the opposite transition).

In conclusion, the following considerations apply:

A Vout-based pulse skip can be easily utilized in multi-level systems, but has difficulties in multi-loop systems: N comparators are needed (where N is number of loops) and, in loops where a current is sensed, current-to-voltage conversion is required (area and power consumption increase). Furthermore the output voltage Vout is not the best point to take decisions: comparators have to be able to detect small variations in order to keep the ripple low (Verr is an amplified version of Vout, so a better point to sense).

A Verr-based pulse skip can be easily utilized in multi-loop systems, but has difficulties in multi-level systems: one skip threshold per level is required; jumping between different levels can introduce latency and worsen the voltage regulation; M-1 comparators are needed (where M is number of levels) as the system needs to know the current level and apply the proper threshold.

The proposed predictor-based pulse skipping on the other hand is insensitive to the number of loops or levels, it always requires one predictor and one comparator to determine where the actual Verr is with respect to the predicted one. Accordingly, it can save area and power as the number of loops and levels increase.

Since this approach still senses a Verr and not a Vout, the advantages of a Verr-based pulse skip remain: no current-to-voltage conversions are needed and the comparator can work with an amplified version of the output voltage.

Better regulation (lower ripple) can be achieved as there is only one skipping threshold that follows the actual Verr: a very small delay occurs when entering or exiting pulse skip mode. This becomes extremely convenient in multi-level systems, where Verr would have to travel a lot between more than one skipping threshold.

It should be noted that the description and drawings merely illustrate the principles of the proposed circuits and methods. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed method. Furthermore, all statements herein providing principles, aspects, and embodiments of the invention, as well as specific examples thereof, are intended to encompass equivalents thereof.

What is claimed is:

1. A switching power converter circuit for receiving an input voltage at an input node and outputting an output voltage at an output node, the switching power converter circuit comprising:
a power stage comprising a plurality of switching elements;
a feedback loop for generating an error voltage of the switching power converter;
a modulator circuit for generating a drive signal for controlling switching operation of the power stage based on the error voltage;
a prediction circuit for generating a prediction of the error voltage based on the input voltage and the output voltage; and
a comparison circuit for comparing the prediction of the error voltage to an actual value of the error voltage and for instructing the modulator circuit to enter a pulse skipping mode based on a result of the comparison.

2. The switching power converter circuit according to claim 1, comprising:
a plurality of feedback loops, each feedback loop generating a respective error voltage; and
a minimizer circuit for receiving the plurality of error voltages and outputting a lowest one of the plurality of error voltages,
wherein the lowest one of the plurality of error voltages is provided to the modulator circuit for generating the drive signal and to the comparison circuit as the actual error voltage for comparison to the prediction of the error voltage.

3. The switching power converter circuit according to claim 1, wherein the comparison circuit instructs the modulator circuit to enter the pulse skipping mode if the actual error voltage is smaller than the prediction of the error voltage.

4. The switching power converter circuit according to claim 1, wherein the comparison circuit is adapted to apply a hysteresis in the comparison of the prediction of the error voltage to the actual value of the error voltage.

5. The switching power converter circuit according to claim 1, wherein the comparison circuit comprises an analog comparator.

6. The switching power converter circuit according to claim 1,
wherein the power stage is a multi-level power stage capable of generating multiple levels of the output voltage; and
wherein the modulator circuit generates a respective drive signal for each one of the multiple levels.

7. The switching power converter circuit according to claim 1, wherein the switching power converter is a buck-boost converter.

8. A switching power converter circuit for receiving an input voltage at an input node and outputting an output voltage at an output node, the switching power converter circuit comprising:
a power stage comprising a plurality of switching elements;
a feedback loop for generating an error voltage of the switching power converter;
a modulator circuit for generating a drive signal for controlling switching operation of the power stage based on the error voltage;
a prediction circuit for generating a prediction of the drive signal for the power stage based on the input voltage and the output voltage; and
a comparison circuit for comparing the prediction of the drive signal to the actual drive signal and for instructing the modulator circuit to enter a pulse skipping mode based on a result of the comparison.

9. The switching power converter circuit according to claim 8, further comprising:
a plurality of feedback loops, each feedback loop generating a respective error voltage; and
a minimizer circuit for receiving the plurality of error voltages and outputting a lowest one of the plurality of error voltages,
wherein the lowest one of the plurality of error voltages is provided to the modulator circuit for generating the drive signal.

10. The switching power converter circuit according to claim 8, wherein the comparison circuit instructs the modulator circuit to enter the pulse skipping mode if a duty cycle of the actual drive signal is smaller than the duty cycle of the prediction of the drive signal.

11. The switching power converter circuit according to claim 8, wherein the comparison circuit is adapted to apply a hysteresis in the comparison of the prediction of the drive signal to the actual drive signal.

12. The switching power converter circuit according to claim 8, wherein the comparison circuit comprises a phase detector.

13. The switching power converter circuit according to claim 8,
wherein the power stage is a multi-level power stage capable of generating multiple levels of the output voltage;
wherein the modulator circuit generates a respective drive signal for each one of the multiple levels; and
wherein the comparison circuit compares, at each time, that drive signal that is currently active to the prediction for the drive signal.

14. The switching power converter circuit according to claim 8, wherein the switching power converter is a buck-boost converter.

15. A method of power conversion using a switching power converter circuit that receives an input voltage at an input node and outputs an output voltage at an output node, the power converter circuit comprising a power stage with a plurality of switching elements, the method comprising the steps of:
generating an error voltage of the switching power converter circuit using a feedback loop;
generating a drive signal for controlling switching operation of the power stage based on the error voltage;
generating a prediction of the error voltage based on the input voltage and the output voltage; and
comparing the prediction of the error voltage to an actual value of the error voltage and entering a pulse skipping mode based on a result of the comparison.

16. The method according to claim 15, comprising the steps of:
generating, using a plurality of feedback loops, a plurality of respective error voltages;
determining a lowest one of the plurality of error voltages;
using the lowest one of the plurality of error voltages for generating the drive signal; and
comparing the lowest one of the plurality of error voltages, as the actual error voltage, to the prediction of the error voltage.

17. The method according to claim 15, further comprising the step of:
entering the pulse skipping mode if the actual error voltage is smaller than the prediction of the error voltage.

18. The method according to claim 15, further comprising the step of:
applying a hysteresis in the comparison of the prediction of the error voltage to the actual value of the error voltage.

19. The method according to claim 15, wherein the comparison is performed using a comparison circuit that comprises an analog comparator.

20. The method according to claim 15,
wherein the power stage is a multi-level power stage capable of generating multiple levels of the output voltage; and
wherein the method comprises generating a respective drive signal for each one of the multiple levels.

21. The method according to claim 15, wherein the switching power converter is a buck-boost converter.

22. A method of power conversion using a switching power converter circuit that receives an input voltage at an input node and outputs an output voltage at an output node, the power converter circuit comprising a power stage with a plurality of switching elements, the method comprising the steps of:
generating an error voltage of the switching power converter circuit using a feedback loop;
generating a drive signal for controlling switching operation of the power stage based on the error voltage;
generating a prediction of the drive signal for the power stage based on the input voltage and the output voltage; and
comparing the prediction of the drive signal to the actual drive signal and entering a pulse skipping mode based on a result of the comparison.

23. The method according to claim 22, further comprising the steps of:
generating, using a plurality of feedback loops, a plurality of respective error voltages;
determining a lowest one of the plurality of error voltages; and
using the lowest one of the plurality of error voltages for generating the drive signal.

24. The method according to claim 22, further comprising the step of: entering the pulse skipping mode if a duty cycle of the actual drive signal is smaller than the duty cycle of the prediction of the drive signal.

25. The method according to claim 22, further comprising the step of: applying a hysteresis in the comparison of the prediction of the drive signal to the actual drive signal.

26. The method according to claim 22, wherein the comparison is performed using a comparison circuit that comprises a phase detector.

27. The method according to claim 22,
wherein the power stage is a multi-level power stage capable of generating multiple levels of the output voltage; and
wherein the method comprises generating a respective drive signal for each one of the multiple levels; and
comparing, at each time, that drive signal that is currently active to the prediction for the drive signal.

28. The method according to claim 22, wherein the switching power converter is a buck-boost converter.
